(19) United States
(12) Patent Application Publication
(10) Pub. No.: US 2025/0210003 A1
(43) Pub. Date: Jun. 26, 2025

(54) DISPLAY DEVICE AND ELECTRONIC DEVICE

(71) Applicant: Wuhan China Star Optoelectronics Technology Co., Ltd., Wuhan, Hubei (CN)

(72) Inventors: Hao SUN, Wuhan, Hubei (CN); Changwen MA, Wuhan, Hubei (CN); Zhou ZHANG, Wuhan, Hubei (CN); Guowei ZHA, Wuhan, Hubei (CN)

(73) Assignee: Wuhan China Star Optoelectronics Technology Co., Ltd., Wuhan, Hubei (CN)

(21) Appl. No.: 18/851,799

(22) PCT Filed: Jun. 29, 2023
(86) PCT No.: PCT/CN2023/104231

§ 371 Date: Sep. 27, 2024

(30) Foreign Application Priority Data
Nov. 4, 2022 (CN) 202211378877.5

(51) Int. Cl. G09G 3/36

(52) U.S. Cl. CPC G09G 3/3607; G09G 2320/041; G09G 2330/021; G09G 2360/144

(57) ABSTRACT

The present application provides a display device and an electronic device. The display device includes a temperature sensor, a signal processor, and a display panel. The signal processor determines whether the ambient temperature is within a predefined temperature range. If the ambient temperature is within the predefined temperature range, the display device operates in the first operating mode with the display panel in color display. If the ambient temperature exceeds the predefined temperature range, the display device operates in the second operating mode with the display panel in monochrome display or grayscale display.

### FIELD OF DISCLOSURE

The present application relates to a field of display technology, specifically to a display device and an electronic device.

### DESCRIPTION OF RELATED ART

Currently, liquid crystal display devices generally consist of a liquid crystal display panel and a backlight module. The liquid crystal display panel is located on a light-emitting side of the backlight module and includes a color filter substrate and an array substrate opposing the color filter substrate. The color filter substrate includes a color filter layer. The white light emitted by the backlight module passes through the color filter layer and changes into light of different colors, thereby enabling the liquid crystal display device to display a color image.

However, the brightness of the white light passing through the color filter layer is significantly reduced, necessitating an increase in backlight brightness and consequently more power consumption. To address this, a color sequential display device has emerged, which employs a time-multiplexing color method (color mode). This method uses different colors of backlight in conjunction with the liquid crystal display panel to produce color effects, thereby eliminating the color filter layer and reducing costs. However, for liquid crystal display panels that use this color mode, significant changes in the environmental temperature of the display device can affect the response time of the liquid crystals and the clarity of the image, leading to display abnormalities.

### SUMMARY OF INVENTION

The present application provides a display device and an electronic device that can adjust an operating mode of the display device based on the ambient temperature, thereby preventing display anomalies and improving visual effects.

The present application provides a display device, the display device including a first operating mode and a second operating mode, the display device including a temperature sensor, a signal process, and a display panel;
wherein the temperature sensor detects an ambient temperature, and the signal processor determines whether the ambient temperature is within a predefined temperature range, wherein when the ambient temperature is within the predefined temperature range, the display device operates in the first working mode, and the display panel is in color display to display in color; when the ambient temperature exceeds the predefined temperature range, the display device operates in the second operating mode, and the display panel is in monochrome display to display in monochrome or in grayscale display to display in monochrome.

Optionally, in some embodiments of the present application, the predefined temperature range is from −10 degrees Celsius to 40 degrees Celsius.

Optionally, in some embodiments of the present application, the display device further includes a backlight module;
wherein in the first operating mode, a backlight driving mode of the backlight module is a color mode; in the second operating mode, the backlight driving mode of the backlight module is a monochrome mode or a grayscale mode.

Optionally, according to some embodiments of the present application, in the color mode, the backlight module includes a plurality of backlight activation phases within a frame, each of the backlight activation phases activating a light source of a different color, with different colors of light sources displayed in different backlight activation phases.

Optionally, according to some embodiments of the present application, in the monochrome display or the grayscale display, the backlight module includes a single backlight activation phase within a frame, and a light source of a single color is activated during the backlight activation phase.

Optionally, in some embodiments of the present application, the display device further includes an environmental color sensor for detecting an ambient color, wherein a backlight color of the backlight module is different from the ambient color.

Optionally, in some embodiments of the present application, the backlight module includes a plurality of backlight activation phases within a frame, each of the backlight activation phases activating a light source of a different color, with different colors of light sources displayed in different backlight activation phases, and durations of at least two of the backlight activation phases are unequal.

Optionally, in some embodiments of the present application, the backlight module includes a single backlight activation phase within a frame, and during the backlight activation phase, activates a light source of a color different from the ambient color.

Optionally, in some embodiments of the present application, when the ambient temperature changes, the display device switches between the first operating mode and the second operating mode during blank periods between adjacent frames.

Optionally, in some embodiments of the present application, the display device further includes an optical sensor for detecting ambient brightness, wherein the display device adjusts backlight brightness of the backlight module based on the ambient brightness.

Correspondingly, the present application further provides an electronic device, the electronic device including a display device, the display device including a first operating mode and a second operating mode, the display device including a temperature sensor, a signal processor, and a display panel;
wherein the temperature sensor detects an ambient temperature, and the signal processor determines whether the ambient temperature is within a predefined temperature range, wherein when the ambient temperature is within the predefined temperature range, the display device operates in the first working mode, and the display panel is in color display to display in color; when the ambient temperature exceeds the predefined temperature range, the display device operates in the second operating mode, and the display panel is in monochrome display to display in monochrome or in grayscale display to display in grayscale.

Optionally, in some embodiments of the present application, the predefined temperature range is from −10 degrees Celsius to 40 degrees Celsius.

Optionally, in some embodiments of the present application, the electronic device further includes a backlight module;
wherein in the first operating mode, a backlight driving mode of the backlight module is a color mode; in the second operating mode, the backlight driving mode of the backlight module is a monochrome mode or a grayscale mode.

Optionally, according to some embodiments of the present application, in the color mode, the backlight module includes a plurality of backlight activation phases within a frame, each of the backlight activation phases activating a light source of a different color, with different colors of light sources displayed in different backlight activation phases.

Optionally, according to some embodiments of the present application, in the monochrome display or the grayscale display, the backlight module includes a single backlight activation phase within a frame, and a light source of a single color is activated during the backlight activation phase.

Optionally, in some embodiments of the present application, the display device further includes an environmental color sensor for detecting an ambient color, wherein a backlight color of the backlight module is different from the ambient color.

Optionally, in some embodiments of the present application, the backlight module includes a plurality of backlight activation phases within a frame, each of the backlight activation phases activating a light source of a different color, with different colors of light sources displayed in different backlight activation phases, and durations of at least two of the backlight activation phases are unequal.

Optionally, in some embodiments of the present application, the backlight module includes a single backlight activation phase within a frame, and during the backlight activation phase, activates a light source of a color different from the ambient color.

Optionally, in some embodiments of the present application, when the ambient temperature changes, the display device switches between the first operating mode and the second operating mode during blank periods between adjacent frames.

Optionally, in some embodiments of the present application, the display device further includes an optical sensor for detecting ambient brightness, wherein the display device adjusts backlight brightness of the backlight module based on the ambient brightness.

### Advantageous Effects

The present application provides a display device and an electronic device which feature a first operating mode and a second operating mode. The display device includes a temperature sensor, a signal processor, and a display panel. The temperature sensor is used to detect the ambient temperature; the signal processor determines whether the ambient temperature is within a predefined temperature range. If the ambient temperature is within the predefined temperature range, the display device operates in the first operating mode with the display panel showing in color; if the ambient temperature exceeds the predefined temperature range, the display device operates in the second operating mode, with the display panel displaying in monochrome or grayscale. The present application allows the display device to adjust its operating mode based on the ambient temperature, enabling the display device to display in an suitable operating mode and prevent display anomalies caused by temperature changes, thus improving visual effects.

### BRIEF DESCRIPTION OF DRAWINGS

To clearly illustrate the technical solutions in the embodiments of the present application, the following is a brief introduction to the drawings used in the description of these embodiments. Obviously, the drawings described below are just some examples of the present application, and those skilled in the art can derive other drawings from these without engaging in creative labor.

FIG. 1 is a first schematic structural diagram of a display device provided by the present application.

FIG. 2 is a second schematic structural diagram of the display device provided by the present application.

FIG. 3 is a schematic diagram illustrating a principle of a backlight driving mode provided by the present application.

FIG. 4 is a third schematic structural diagram of the display device provided by the present application.

FIG. 5 is a process flow diagram of the display device provided by the present application.

### DETAILED DESCRIPTION OF EMBODIMENTS

The following provides a clear and complete description of the technical solutions in the embodiments of the present application, using the accompanying drawings. It should be noted that the described embodiments are only a part of this application, and not all the embodiments. All other embodiments derived by those skilled in the art without creative effort are also within the scope of this application.

In the description of this application, it is important to understand that the terms “first” and “second” are used solely for descriptive purposes and should not be construed as indicating or implying relative importance or suggesting the number of technical features indicated. Hence, characteristics labeled “first” and “second” may explicitly or implicitly include one or more of the specified features and should not be seen as limiting this application. Additionally, unless otherwise specified, terms like “connected” or “coupled” should be understood broadly, for example, connections can be mechanical or electrical; they can be direct or indirect through an intermediary; they can involve internal connections or communication between two components. The specific meaning of these terms in this invention can be understood by those skilled in the art depending on the context.

The present application provides a display device and an electronic device, which are detailed below. It should be noted that the order of description of the following embodiments is not intended to prioritize or suggest a preferred sequence of the embodiments.

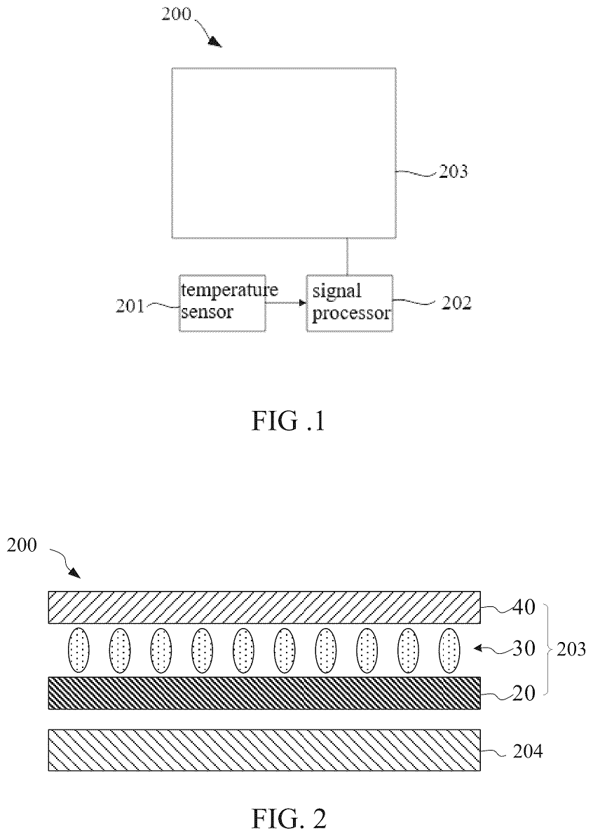

Refer to FIG. 1, which is a schematic diagram of the first structure of the display device provided by this application. In this example of the application, the display device 200 includes a temperature sensor 201, a signal processor 202, and a display panel 203.

The temperature sensor 201 is used to detect the ambient temperature. The signal processor 202 determines whether the ambient temperature is within a predefined temperature range. If the ambient temperature is within this range, the display device 200 operates in the first working mode, with the display panel 203 displaying in color. If the ambient temperature exceeds this range, the display device 200 switches to the second working mode, with the display panel 203 displaying in monochrome or grayscale.

The term “ambient temperature” refers to the temperature of the environment in which the display device 200 is located.

The signal processor 202 can be a microprocessor or other control chip. Once the temperature sensor 201 detects the ambient temperature, the signal processor 202 can determine whether the detected temperature falls within the predefined temperature range. For example, the signal processor 202 can compare the ambient temperature with the maximum and minimum values of the predefined temperature range; if the ambient temperature is greater than or equal to the minimum value and less than or equal to the maximum value, then the display device 200 operates in the first operating mode. If the ambient temperature is less than the minimum value or greater than the maximum value, then the display device 200 operates in the second operating mode.

In the present embodiment, the ambient temperature is obtained via the temperature sensor 201, and compared with a predefined temperature range. This allows for the adjustment of the operating mode of the display device 200 based on the ambient temperature, ensuring that the display device 200 operates in the appropriate operating mode and preventing display abnormalities caused by changes in ambient temperature.

In the present embodiment, the predefined temperature range is from −10 degrees Celsius to 40 degrees Celsius. For instance, the temperature range can be set from −10 degrees Celsius to 10 degrees Celsius, from 10 degrees Celsius to 30 degrees Celsius, or from 30 degrees Celsius to 40 degrees Celsius, depending on the specific characteristics of the display device 200, such as the properties of liquid crystal rotation.

In some examples, as shown in FIGS. 1 and 2, the display device 200 also includes a backlight module 204. Specifically, the display panel 203 includes an array substrate 20, a color filter substrate 40, and a liquid crystal layer 30. The array substrate 20 and the color filter substrate 40 are set opposite each other, with the liquid crystal layer 30 located between the array substrate 20 and the color filter substrate 40. The backlight module 204 is positioned on one side of the array substrate 20 that is away from the color filter substrate 40. The backlight module 204 provides the necessary backlight for the display panel 203 to display images.

The backlight module 204 has different backlight operating modes corresponding to the different operating modes of the display device 200.

The “backlight operating mode” can include backlight driving modes such as color mode, monochrome mode, and grayscale mode. Specifically, if the display device 200 operates in the first operating mode, the backlight driving mode of the backlight module 204 is color mode. If the display device 200 operates in the second operating mode, the backlight driving mode of the backlight module 204 is monochrome mode or grayscale mode. The backlight operating mode can also include backlight colors such as blue, green, purplish, reddish, etc., as well as backlight brightness.

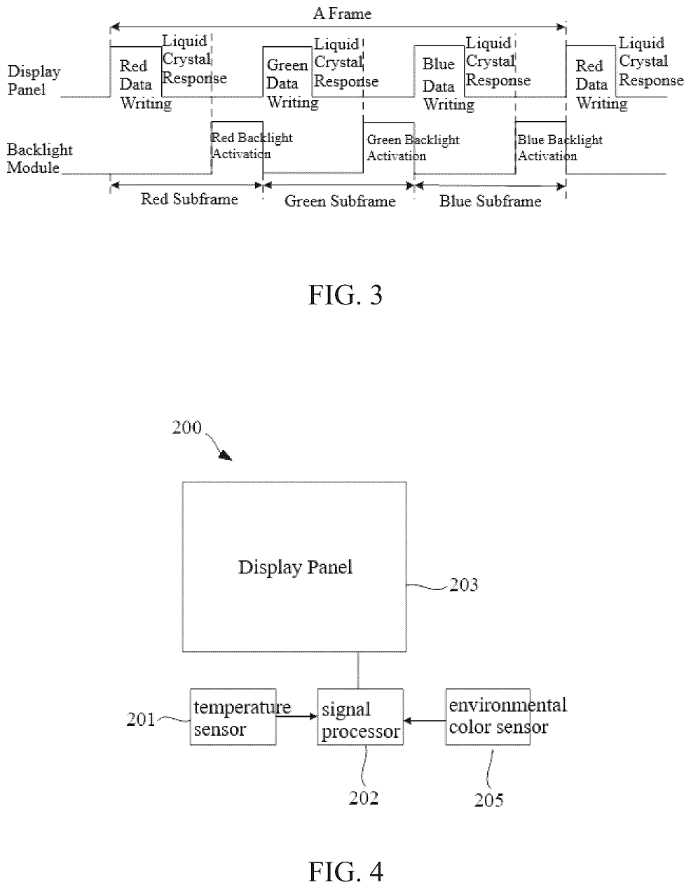

The “color mode” refers to using time-multiplexing of colors, where different colors of backlight are combined with the liquid crystal display panel to produce a color effect. For example, as shown in FIG. 3, the display panel 203 includes multiple frames displayed, with each frame including at least two subframes. Each subframe includes a data writing phase, a liquid crystal response phase, and a backlight activation phase, which occur sequentially within each subframe. In color mode, the display panel 203 can display color images, meaning the display panel 203 displays in color.

Specifically, the present embodiment illustrates with each frame consisting of three subframes: a red subframe, a green subframe, and a blue subframe. When red data signals are written to the display panel 203, the backlight is turned off, and the red backlight is turned on after the red data has been written and the liquid crystal has responded for a period. Similarly, when green data signals are written to the display panel 203, the backlight is turned off, and the green backlight is turned on after the green data has been written and the liquid crystal has responded for a period. When blue data signals are written to the display panel 203, the backlight is turned off, and the blue backlight is turned on after the blue data has been written and the liquid crystal has responded for a period. Thus, the red, green, and blue subframes are displayed sequentially, achieving the time multiplexing effect of RGB.

The “monochrome mode” refers to a frame that only includes one data writing phase, one liquid crystal response phase, and one backlight activation phase. During this backlight activation phase, only one of the red backlight, green backlight, or blue backlight is turned on. In the monochrome mode, the display panel 203 can only display images in one color, meaning the display panel 203 displays in monochrome.

It should be noted that in the color mode, the display panel 203 can also display images in solid color, but due to the different backlight driving mode, the color display at this time is different from the monochrome display.

The “grayscale mode” refers to a frame that includes one data writing phase, one liquid crystal response phase, and one backlight activation phase as well. During this backlight activation phase, the backlight color is white, which, in combination with different angles of liquid crystal rotation, results in the display panel 203 presenting a grayscale image, meaning display panel 203 displays in grayscale.

It is understandable that the response time of liquid crystals changes with temperature variations. When there is a significant change in ambient temperature, the response time of the liquid crystals also changes substantially. If the ambient temperature exceeds the predefined temperature range, the response time of the liquid crystals increases; in such cases, if the backlight module 204 is in color mode, when the color data for the next subframe is about to be written, the liquid crystals from the previous subframe may not have rotated to the correct angle yet, affecting the color displayed and consequently leading to display anomalies. If the backlight module 204 is in monochrome mode or grayscale mode, then a frame only includes one backlight activation phase, providing ample time to ensure the liquid crystals can rotate to the correct angle, thus avoiding display anomalies.

Therefore, in color display mode, the backlight module 204 includes multiple backlight activation phases within a frame, with each backlight activation phase turning on a light source of a different color.

In monochrome mode or grayscale display mode, the backlight module 204 includes one backlight activation phase per frame, turning on a single color light source during the backlight activation phase.

In some embodiments of the present application, as shown in FIG. 4, the display device 200 also includes an environmental color sensor 205. The environmental color sensor 205 is used to detect ambient colors. The color of the backlight from the backlight module 204 is different from the ambient color.

Specifically, the display device 200 can also include a central processor (not shown in the drawings). When the environmental color sensor 205 detects an ambient color, the signal processor 202 is also used to process the detected ambient color information, such as through analog-to-digital conversion, and then the analog-to-digital converted data is transmitted to the central controller. The central controller controls the backlight module 204 based on the analog-to-digital converted data, enabling the backlight to display the corresponding color.

It is understandable that the environment in which the display device 200 is located acts as the background for a display screen. When there is little color difference between the ambient color and the display screen color, it can affect the clarity of the display seen by the human eye, degrading the visual effect. By setting the backlight color differently from the ambient color, the present embodiment increases the color contrast between the display screen and the ambient color, ensuring the correct visual information is perceived by the viewer.

Specifically, in some embodiments, the backlight color is the complementary color to the ambient color, which can further enhance the color contrast between the display screen and the environment, improving the visual effect.

The color wheel is a circular arrangement of the color spectrum, where the colors are arranged in the order they appear in nature. Complementary colors refer to two colors on the color wheel that are between 120 and 180 degrees apart. Since complementary colors are far apart on the color wheel, the color difference is significant, resulting in a more intense and brighter visual effect.

For example, when driving in a hot area (such as a desert), the ambient color around the display device 200 may be yellow. At this time, based on the data fed back by the signal processor 202, the central processor can control the backlight to show a reddish color, creating a strong red-yellow contrast. Similarly, when driving in an area shaded by green trees, the ambient color may lean towards green. Here, the central processor, informed by the signal processor 202, can adjust the backlight to a purplish color, resulting in a strong green-purple contrast.

It should be noted that if the effects of both ambient temperature and ambient color on the backlight operating mode are considered, when determining the backlight color based on the ambient color, the adjustment method of the backlight color needs to be determined according to the backlight driving mode of the display device 200.

Specifically, in some embodiments, as mentioned above, when the backlight driving mode of the backlight module 204 is color mode, it actually employs a time multiplexing method to display color effects with backlights of different colors in combination with the liquid crystal display panel. Each frame includes at least two subframes, each subframe including a backlight activation phase.

The term “multiple” refers to two or more. In some embodiments, the display device 200 can include three subframes within a frame, such as a red subframe, a green subframe, and a blue subframe. In some embodiments, the display device 200 can also include four subframes, such as red, green, blue, and white subframes.

Typically, in color mode, the durations of different subframes are equal, and the durations of different backlight activation phases are equal, so the backlight color presented in time multiplexing is white. In the present embodiment, by setting the durations of at least two backlight activation phases to be different, i.e., adjusting the duration ratios of multiple backlight activation phases, the backlight color can be adjusted according to the principles of time-multiplexing to ensure that the backlight color is different from the ambient color.

For example, when the ambient color around the display device 200 is yellowish, the backlight should be controlled to appear reddish. At this time, the duration proportion of the backlight activation phase corresponding to the red light source can be increased to make the backlight color appear more reddish. Similarly, when the ambient color around the display device 200 is greenish, since a certain proportion of blue and red equals purple, the duration proportions of the backlight activation phases for the blue and red light sources can be increased, thereby making the backlight color appear purplish.

In other embodiments, as mentioned above, when the backlight driving mode of the backlight module 204 is monochrome mode or grayscale mode, a frame only includes one data writing phase, one liquid crystal response phase, and one backlight activation phase. That is, during this backlight activation phase, only one of the backlights such as red, green, blue, or white is turned on.

Specifically, during the backlight activation phase, it is sufficient to turn on a light source that differs in color from the ambient color. For instance, when the ambient color around the display device 200 is greenish, any one of a red light source, a blue light source, or a white light source can be turned on, but not the green light source. This enhances the color contrast between the ambient color and the backlight color, improving the visual quality of the display.

Of course, if the backlight sources of the display device 200 include a color that is complementary to the ambient color, the light source with the complementary color can also be directly turned on during the backlight activation phase.

In some embodiments of the present application, the display device 200 can also include an optical sensor. The optical sensor is used to detect ambient brightness, allowing display device 200 to adjust the backlight brightness of the backlight module 204 based on the ambient brightness.

It is understandable that if the ambient light is too dim and the display screen is too bright, not only does it cause discomfort to the eyes of the viewers, but it also increases power consumption; if the ambient light is too bright and the display screen is too dim, the display image appears unclear to the user. Therefore, by adjusting the backlight brightness of the backlight module 204 based on the ambient light information, the brightness of the display screen can be adjusted according to the ambient brightness, thereby ensuring viewer comfort and reducing the power consumption of display device 200.

Specifically, a brightness preset value can be set; when the ambient brightness is greater than or equal to this brightness preset value, the backlight brightness is increased; when the ambient brightness is below this brightness preset value, the backlight brightness is decreased.

In some embodiments of this application, when the ambient temperature changes, the display device 200 can switch between the first operating mode and the second operating mode during the blank periods between adjacent frames. Of course,

Certainly, it is understood that after the display device 200 is powered on, the display device 200 can detect the ambient temperature in real time. When the environment around the display device 200 changes, the obtained ambient temperature information changes accordingly, necessitating an adjustment in the operating mode of the display device 200 to prevent display anomalies. Of course, when other environmental information such as ambient color changes, the display device 200 can also adjust the backlight operating mode of the backlight module 204 during the blank periods between adjacent frames.

The embodiment of the present application facilitates changing the operating mode of the display device 200 during the blank periods between adjacent frames to avoid impacting the transition of the display screen while also making efficient use of the blank periods. Furthermore, a frame can be divided into at least a data writing phase, a liquid crystal response phase, and a backlight activation phase. Since the display panel 203 does not require additional actions during the liquid crystal response phase and the backlight activation phase, the operating mode of the display device 200 can also be adjusted during the liquid crystal response phase and the backlight activation phase to enhance the utilization of the liquid crystal response phase and the backlight activation phase.

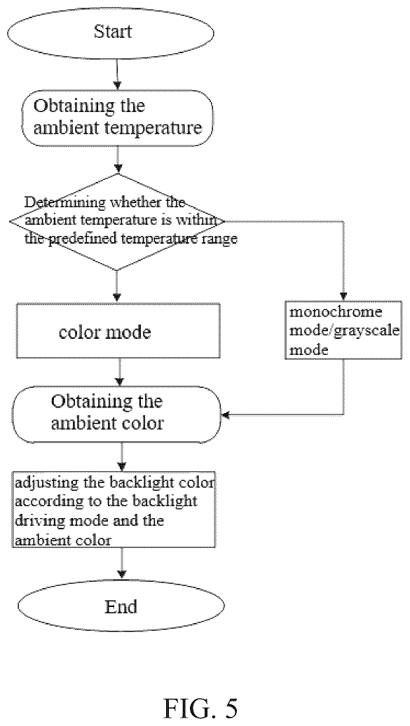

Specifically, please refer to FIG. 5, where the technical solution of the present application is detailed using a specific embodiment.

After the display device is powered on, meaning when it starts operating, the ambient temperature can be obtained through the temperature sensor. Then, it is determined whether the ambient temperature is within the predefined temperature range. If the ambient temperature is within the predefined temperature range, the display device operates in the first operating mode, and in the first operating mode, the color mode is selected as the backlight driving mode for the backlight module. If the ambient temperature exceeds the predefined temperature range, the display device operates in the second operating mode, and in the second operating mode, the monochrome mode or the grayscale mode is selected as the backlight driving mode for the backlight module. Subsequently, the ambient color can be obtained through the environmental color sensor. Once the ambient color is detected, the backlight color is adjusted according to the backlight driving mode and the ambient color.

Specifically, if the backlight driving mode is set to the color mode, the backlight module is configured to include at least two backlight activation phases within a frame, each backlight activation phase activating a light source of a different color; different backlight activation phases activate different color light sources. By adjusting the duration ratios of multiple backlight activation phases, the backlight color can be altered to differ from the ambient color. If the backlight driving mode is set to monochrome mode or grayscale mode, then the backlight module includes a single backlight activation phase within a frame, activating a light source of a color different from the ambient color during the backlight activation phase. For more details, please refer to the embodiments mentioned above; further elaboration is not provided here.

Correspondingly, the present application also provides an electronic device that includes the display device described above. For specifics, please refer to the content mentioned above; it is not reiterated here. This electronic device can be a vehicle display, a portable display, or other types of display products that are commonly used in environments subject to changes, such as Heads Up Displays (HUDs), smartphones, tablets, video players, etc. Certainly, the present application is not limited to these examples.

This application provides an electronic device that includes a display device. The display device features a first operating mode and a second operating mode and includes a temperature sensor, a signal processor, and a display panel. The temperature sensor is used to detect the ambient temperature; the signal processor determines whether the ambient temperature is within a predefined temperature range. If the ambient temperature is within the predefined temperature range, the display device operates in the first operating mode with the display panel displaying in color. If the ambient temperature exceeds the predefined temperature range, the display device operates in the second operating mode with the display panel displaying in monochrome or grayscale. This application allows the display device to adjust its operating mode based on the ambient temperature, enabling the display device to display in a suitable operating mode. For instance, when the electronic device is a vehicle display, the position of the vehicle display changes significantly, and the ambient temperature varies accordingly. The implementation of this application can improve the visual performance of the vehicle display, enhancing safety during driving.

The above has provided a detailed introduction to the embodiments of the present application, applying specific instances to elaborate on the principles and methods of this application. The descriptions of the above embodiments are intended only to aid in understanding the method and core ideas of this application; therefore, for those skilled in the art, changes in specific embodiments and applications may arise based on the ideas of this application. Consequently, the content of this specification should not be construed as limiting the scope of this application.

What is claimed is:

1. A display device, the display device comprising a first operating mode and a second operating mode, the display device comprising:
a temperature sensor for detecting an ambient temperature;
a signal processor for determining whether the ambient temperature is within a predefined temperature range; and
a display panel;
wherein when the ambient temperature is within the predefined temperature range, the display device operates in the first working mode, and the display panel is in color display to display in color; when the ambient temperature exceeds the predefined temperature range, the display device operates in the second operating mode, and the display panel is in monochrome display to display in monochrome or in grayscale display to display in monochrome.

2. The display device according to claim 1, wherein the predefined temperature range is from −10 degrees Celsius to 40 degrees Celsius.

3. The display device according to claim 1, further comprising:
a backlight module;
wherein in the first operating mode, a backlight driving mode of the backlight module is a color mode; in the second operating mode, the backlight driving mode of the backlight module is a monochrome mode or a grayscale mode.

4. The display device according to claim 3, wherein in the color mode, the backlight module comprises a plurality of backlight activation phases within a frame, each of the backlight activation phases activating a light source of a different color, with different colors of light sources displayed in different backlight activation phases.

5. The display device according to claim 3, wherein in the monochrome display or the grayscale display, the backlight module comprises a single backlight activation phase within a frame, and a light source of a single color is activated during the backlight activation phase.

6. The display device according to claim 3, further comprising an environmental color sensor for detecting an ambient color, wherein a backlight color of the backlight module is different from the ambient color.

7. The display device according to claim 6, wherein the backlight module comprises a plurality of backlight activation phases within a frame, each of the backlight activation phases activating a light source of a different color, with different colors of light sources displayed in different backlight activation phases, and durations of at least two of the backlight activation phases are unequal.

8. The display device according to claim 6, wherein the backlight module comprises a single backlight activation phase within a frame, and during the backlight activation phase, activates a light source of a color different from the ambient color.

9. The display device according to claim 1, wherein when the ambient temperature changes, the display device switches between the first operating mode and the second operating mode during blank periods between adjacent frames.

10. The display device according to claim 3, further comprising an optical sensor for detecting ambient brightness, wherein the display device adjusts backlight brightness of the backlight module based on the ambient brightness.

11. An electronic device, the electronic device comprising a display device, the display device comprising a first operating mode and a second operating mode, the display device comprising:
a temperature sensor for detecting an ambient temperature;
a signal processor for determining whether the ambient temperature is within a predefined temperature range; and
a display panel;
wherein when the ambient temperature is within the predefined temperature range, the display device operates in the first working mode, and the display panel is in color display to display in color; when the ambient temperature exceeds the predefined temperature range, the display device operates in the second operating mode, and the display panel is in monochrome display to display in monochrome or in grayscale display to display in grayscale.

12. The electronic device according to claim 11, wherein the predefined temperature range is from −10 degrees Celsius to 40 degrees Celsius.

13. The electronic device according to claim 11, further comprising:
a backlight module;
wherein in the first operating mode, a backlight driving mode of the backlight module is a color mode; in the second operating mode, the backlight driving mode of the backlight module is a monochrome mode or a grayscale mode.

14. The electronic device according to claim 13, wherein in the color mode, the backlight module comprises a plurality of backlight activation phases within a frame, each of the backlight activation phases activating a light source of a different color, with different colors of light sources displayed in different backlight activation phases.

15. The electronic device according to claim 13, wherein in the monochrome display or the grayscale display, the backlight module comprises a single backlight activation phase within a frame, and a light source of a single color is activated during the backlight activation phase.

16. The electronic device according to claim 13, further comprising an environmental color sensor for detecting an ambient color, wherein a backlight color of the backlight module is different from the ambient color.

17. The electronic device according to claim 16, wherein the backlight module comprises a plurality of backlight activation phases within a frame, each of the backlight activation phases activating a light source of a different color, with different colors of light sources displayed in different backlight activation phases, and durations of at least two of the backlight activation phases are unequal.

18. The electronic device according to claim 16, wherein the backlight module comprises a single backlight activation phase within a frame, and during the backlight activation phase, activates a light source of a color different from the ambient color.

19. The electronic device according to claim 11, wherein when the ambient temperature changes, the display device switches between the first operating mode and the second operating mode during blank periods between adjacent frames.

20. The electronic device according to claim 13, further comprising an optical sensor for detecting ambient brightness, wherein the display device adjusts backlight brightness of the backlight module based on the ambient brightness.
